(19) United States
(12) Patent Application Publication
(10) Pub. No.: US 2018/0350250 A1
(43) Pub. Date: Dec. 6, 2018

(54) NETWORK TERMINAL-BASED LEARNING DISPLAY DEVICE

(71) Applicants: YINING MA, SHANGHAI (CN); ZHENGFANG MA, SHANGHAI (CN)

(72) Inventors: YINING MA, SHANGHAI (CN); ZHENGFANG MA, SHANGHAI (CN)

(21) Appl. No.: 15/740,905

(22) PCT Filed: Jun. 30, 2016
(86) PCT No.: PCT/CN2016/087807

§ 371 Date: Jun. 9, 2018

(30) Foreign Application Priority Data
Jul. 1, 2015 (CN) 201510377628.8

(51) Int. Cl. G09B 5/08; G06F 3/0484; G06F 3/0488

(52) U.S. Cl. CPC G09B 5/08; G06T 11/206; G06F 3/04883; G06F 3/04845

(57) ABSTRACT

A network terminal-based learning display device. The learning display device comprises a network terminal (1c) and a server (2c). The network terminal (1c) comprises: a knowledge point structure display module (11c), configured to display a knowledge point structure in a first display mode on a first portion of a display screen, wherein the displayed knowledge point structure comprises a current knowledge point; a knowledge point content display module (12c), configured to display content of the current knowledge point on a second portion of the display screen; and a first transmission module (13c), configured to transmit data in the network terminal to the server (2c); and the server (2c) comprises: a knowledge point storage module (22c), configured to store a classification, a structural relationship, a label, and content of a knowledge point; and a second transmission module (21c), configured to transmit data in the knowledge point storage module to the network terminal (1c).

### BACKGROUND OF THE PRESENT INVENTION

### Field of Invention

The present invention relates to an Internet learning system, and in particular, to an online learning system based on a network terminal, and in particular, based on a mobile terminal.

### Description of Related Arts

During online learning, knowledge is generally classified, and the elementary unit of the entire knowledge system is referred to as a knowledge point. For example, a knowledge point in the Baidupedia is also referred to as a vocabulary entry. There may be logic relationships between a plurality of knowledge points, for example, a parallel relationship, an inclusion relationship, or a causal relationship.

Conventional online learning is also learning based on the knowledge points, but the knowledge points are basically displayed in a text list form. For example, in the Baidupedia, a user obtains a related entry by entering a search term. The Baidupedia displays content of the entry, information about an editor, and the like on the page. In addition, an entry associated with the entry is displayed, and the associated entries generally occur in the content of the entry, and are provided by using network links. The user enters the entry corresponding to the link by clicking the link.

However, such a relation between the entries is a weak connection, and basically, there is no strong logic relationship because the connection is only established when another entry appears in the explanation of the current entry. If a user specially needs to learn knowledge of a particular type, the user cannot perform learning in a manner such as Baidupedia. Because there is no logic relationship between the entries needing to be learned, it is impossible to build a knowledge system for the user.

Furthermore, for the knowledge points listed in the text list form, it is difficult for a learner to obtain intuitive feeling of the relationships between the knowledge points, and the text list method is preferably displayed on a large screen, for example, a computer display screen. In this mobile Internet era, if the learner learns by using a smartphone, it is difficult for the user to accept the method of displaying the knowledge points in the text list form.

Another learning method is to make courseware of the knowledge points needing to be learned and upload the courseware to the Internet. A user downloads the courseware or learns the courseware online. Such a courseware learning method is only a replication of the conventional class learning onto the network; it is not consistent with the learning manner based on Internet thinking. A learner only passively receives the knowledge points provided on the courseware, rather than actively learning the knowledge points and building a knowledge system based on the knowledge points. On one hand, such a learning system may lower the learner's interest in active learning; on the other hand, it is difficult to help, in such a non-global learning method, the learner construct a systematic and complete knowledge structure.

### SUMMARY OF THE PRESENT INVENTION

The following gives a brief summary of one or more aspects to provide a basic understanding of these aspects. The summary is not a detailed overview of all contemplated aspects, and is intended to neither identify key or critical elements of all aspects nor delineate the scope of any or all aspects. The sole objective of the summary is to present some concepts of one or more aspects in a simplified form as a prelude to a more detailed description that is presented later.

The objective of the present invention is to resolve the foregoing problems. A network terminal-based learning display device is provided, and can help a learner to build a knowledge structure system of the learner based on learned knowledge points, increase the learner's initiative of active learning, improve the learning efficiency of the learner, miniaturize this learning method, and make this learning method more portable. Therefore, the knowledge points and structural relationships thereof are displayed by using a smartphone, so that the learner can learn at any time and any place, and take full advantage of fragmented time.

The technical solution of the present invention is: The present invention discloses a network terminal-based learning display device, comprising a network terminal and a server, wherein

the network terminal comprises:

a knowledge point structure display module, configured to display a knowledge point structure in a first display mode on a first portion of a display screen of the network terminal, wherein the displayed knowledge point structure comprises a current knowledge point;

a knowledge point content display module, configured to display content of the current knowledge point on a second portion of the display screen of the network terminal; and

a first transmission module, configured to transmit data in the network terminal to the server; and

the server comprises:

a knowledge point storage module, configured to store a classification, a structural relationship, a label, and content of a knowledge point; and

a second transmission module, configured to transmit data in the knowledge point storage module to the network terminal.

According to an embodiment of the network terminal-based learning display device consistent with the present invention, the first display mode is a star graph display mode, the knowledge point structure display module comprises a star graph display unit, and the star graph display unit is configured to display the knowledge point structure in the star graph display mode on the first portion of the display screen of the network terminal.

According to an embodiment of the network terminal-based learning display device consistent with the present invention, the knowledge point structure display module is further configured to display the knowledge point structure in a second display mode on the first portion of the display screen of the network terminal, wherein the displayed knowledge point structure comprises the current knowledge point; and

the network terminal further comprises:

a display mode switching module, configured to switch between the first display mode and the second display mode according to user's input.

According to an embodiment of the network terminal-based learning display device consistent with the present invention, the second display mode is a tree graph display mode, the knowledge point structure display module comprises a tree graph display unit, and the tree graph display unit is configured to display the knowledge point structure in the tree graph display mode on the first portion of the display screen of the network terminal.

According to an embodiment of the network terminal-based learning display device consistent with the present invention, the knowledge point storage module is configured to store the structural relationships, the labels, and the content of the knowledge points by using a tree data structure.

According to an embodiment of the network terminal-based learning display device consistent with the present invention, the knowledge point structure display module displays the structural relationships of the knowledge points in the star graph display mode, and N parent nodes, N neighboring brother nodes, and N child nodes centering on the current knowledge point are displayed on the first portion of the display screen of the network terminal, wherein N is a natural number greater than or equal to 1, a label of knowledge point is displayed on a node of a star graph, and a connecting line or an arrow between nodes represents a structural relationship between knowledge points.

According to an embodiment of the network terminal-based learning display device consistent with the present invention, a node of a star graph is represented by using a rectangular box, text in the rectangular box is a label of a knowledge point, and light or shade of an edge of the rectangular box respectively represent whether there is a structural relationship between knowledge points or not.

According to an embodiment of the network terminal-based learning display device consistent with the present invention, the network terminal further comprises:

a gesture recognition module, configured to recognize an operation gesture of a user on the star graph displayed on the first portion of the display screen of the network terminal, and move, based on the gesture, the node displayed on the star graph.

According to an embodiment of the network terminal-based learning display device consistent with the present invention, the knowledge point structure display module of the learning display device is further configured to display the knowledge point structure in a third display mode on the first portion of the display screen of the network terminal, wherein the third display mode is an implication graph mode; the knowledge point structure display module further comprises an implication graph display unit, and the implication graph display unit is configured to display the knowledge point structure in an implication graph display mode on the first portion of the display screen of the network terminal; and the display mode switching module is configured to receive the input of the user, then switch between the first display mode, the second display mode, and the third display mode accordingly.

According to an embodiment of the network terminal-based learning display device consistent with the present invention, wherein the content of the current knowledge point displayed by the knowledge point content display module comprises text content and multimedia content of the knowledge point.

Compared with the prior art, the present invention has the following beneficial effects: the technical solution of the present invention is to display the knowledge point structure in a plurality of display modes, for example, the star graph display mode, the tree graph display mode, or the implication graph display mode, on the display screen of the network terminal (especially, a mobile terminal). A touchscreen on a smartphone can detect the gesture operation of the user on a display interface, and update, according to the recognized gesture operation, the knowledge point structure displayed on the display interface. A position of the current knowledge point in the entire knowledge point structure is preferably displayed by using a tree graph, which is also referred to as an entire display. Relationships between the current knowledge point and neighboring knowledge points thereof in the entire knowledge point structure are preferably displayed by using a star graph or an implication graph, which is also referred to as a local display. A switch may be performed between the three display modes according to the input of the user. In a local display mode, the relationships between the current knowledge point and the neighboring knowledge points thereof in the entire knowledge point structure are displayed in one portion of the display screen, and the content of the current knowledge point is displayed in the other portion of the display screen. Compared with a conventional network education system, the device consistent with the present invention has the following advantages:

(1) The knowledge point structure is displayed by a graphical method, which may provide better intuitive feeling for the learners.

(2) Display of the knowledge point structure may be switched between the entire tree graph and the local star graph (or implication graph), which facilitates the learner in better mastering the position of the current knowledge point in the entire knowledge point structure system.

(3) The knowledge point structure presented by the star graph is preferably operated on a display screen with a smaller size, especially on a touchscreen of a smartphone. The learner may operate the star graph with a slide gesture or a click gesture on the touchscreen, and a perfect match between the knowledge learning and the mobile terminal is really achieved.

### BRIEF DESCRIPTION OF THE DRAWINGS

FIG. 1 shows a principle diagram of a first embodiment of a network terminal-based learning display device according to the present invention;

FIG. 2 shows a principle diagram of a second embodiment of a network terminal-based learning display device according to the present invention;

FIG. 3 shows a principle diagram of a third embodiment of a network terminal-based learning display device according to the present invention;

FIG. 4A to FIG. 4C show exemplary diagrams of displaying a knowledge point structure by using a star graph;

FIG. 5 shows an exemplary diagram of displaying a knowledge point structure by using a tree graph; and

FIG. 6A and FIG. 6B show exemplary diagrams of displaying a knowledge point structure by using an implication graph.

### DETAILED DESCRIPTION OF THE PREFERRED EMBODIMENTS

The foregoing features and advantages of the present invention will be better understood after detailed descriptions of embodiments of the present invention with reference to the accompanying drawings are read. In the accompanying drawings, components are not necessarily drawn to scale, and components with similar related characteristics or features may have similar or same accompanying drawing numerals.

First Embodiment of a Network Terminal-Based Learning Display Device

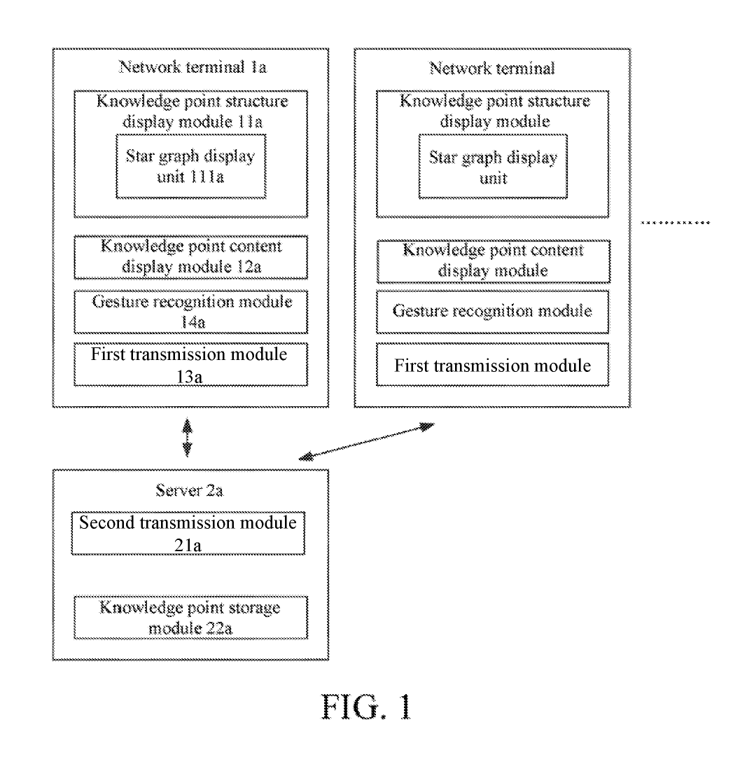

FIG. 1 shows the principle of the first embodiment of the network terminal-based learning display device according to the present invention. Referring to FIG. 1, the network terminal-based learning display device according to this embodiment comprises a network terminal 1a and a server 2a. The network terminal 1a may be a computer having a network function, or a smartphone, and establishes a communications connection to the server 2a by using the Internet or a mobile communications network.

The server 2a comprises a second transmission module 21a and a knowledge point storage module 22a. The second transmission module 21a is configured to transmit all or a part of data in the knowledge point storage module 22a to the network terminal 1a. The knowledge point storage module 22a is configured to store a classification, a structural relationship, a tag, and content of a knowledge point. The classification of the knowledge point refers to a category defined by an editor for the knowledge point. For example, “Belt and Road” is classified into the “economy” category under editing of a user A, but may be classified into the “politics” category under editing of a user B. Different users may classify a same knowledge point into different classifications due to their different understandings.

The label of the knowledge point is similar to a name of the knowledge point. For example, “Belt and Road” is the label of this knowledge point. The content of the knowledge point is a specific definition of the knowledge point. For example, what “Belt and Road” specifically refers to is the content under the “Belt and Road” label.

The structural relationship of the knowledge point refers to a logic relationship between knowledge points. The logic relationship is preferably expressed by using a tree data structure. A parent-child node relationship represents a hierarchy relationship between the knowledge points, and a brother node relationship represents a parallel relationship between the knowledge points. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-Hebei Integration Plan”, “Yangtze River Economic Zone”, “Free Trade Area”, “Western Region Development”, “Revitalization of Northeast”, and the like.

When an editor enters a knowledge point, in addition to content of the knowledge point, the editor further enters relationships between the knowledge point and other knowledge points. For example, for a currently entered knowledge point A and an existing knowledge point B, when the knowledge point A is entered, a relationship between the knowledge point A and the knowledge point B is also entered, the relationship may be classified into: no relationship between A and B, or a parallel relationship between A and B. If there is the parallel relationship between A and B, it indicates that granularities of the knowledge points A and B are the same. The parallel relationship may further be classified into three categories, namely, a causal relationship, no causal relationship but with a learning sequence, no causal relationship and no learning sequence.

Similarly, for the currently entered knowledge point A and a plurality of existing knowledge points B, C, D, and the like, there is no relationship or there is a parallel relationship (the parallel relationship is further classified into three categories, namely, a causal relationship, no causal relationship but with a learning sequence, no causal relationship and no learning sequence) therebetween. Furthermore, there is an implication/subordinate relationship between the knowledge point A and the plurality of existing knowledge points B, C, D, and the like.

The network terminal 1a comprises a knowledge point structure display module 11a, a knowledge point content display module 12a, and a first transmission module 13a. The first transmission module 13a is configured to transmit data in the network terminal 1a to the server 2a.

The display of the knowledge point on the network terminal comprises two portions. One portion is the position of the current knowledge point in an entire knowledge structure and relationships between the current knowledge point and other neighboring knowledge points of the current knowledge point, that is, a display of the knowledge point structure. The other portion is specific content of the current knowledge point, that is, a display of the content of the knowledge point. The former is implemented by using the knowledge point structure display module 11a, and the latter is implemented by using the knowledge point content display module 12a.

A display screen of the network terminal 1a comprises two portions, for example, an upper portion and a lower portion, or a left portion and a right portion. In this embodiment, the upper portion and the lower portion are used as an example for description. In this embodiment, the knowledge point structure display module 11a comprises a star graph display unit 111a. The star graph display unit 111a is configured to display the knowledge point structure in a star graph display mode on the upper portion of the display screen of the network terminal, and the displayed knowledge point structure comprises the current knowledge point. Correspondingly, the knowledge point content display module 12a is configured to display the content of the current knowledge point on the lower portion of the display screen of the network terminal.

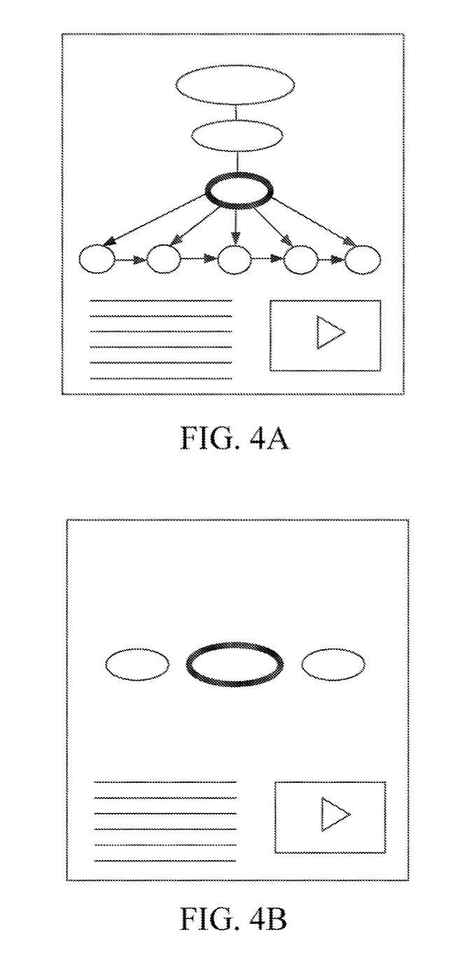

The knowledge point structure displayed in the star graph display mode is shown in FIG. 4A to FIG. 4C. In FIG. 4A, a structure of a knowledge point displayed in the star graph display mode is displayed on the upper portion of the display screen. The current knowledge point is located in the center, an upper level of the current knowledge point is a parent node, and a still upper level is a grandparent node (that is, parent node of the parent node), and so on. A lower level of the current knowledge point is a child node, and a still lower level is a grandchild node (that is, child node of the child node), and so on. Because there are too many nodes when it comes to the grandchild node, generally, the current knowledge point is preferably unfolded to the level of the child nodes. A left node or a right node of the current knowledge point is a brother node. The relationships between the knowledge points are expressed by using connecting lines between the knowledge points. In terms of a data structure, such relationships are the foregoing parent-child relationship, brother relationship, or the like. In terms of a logic relationship, such relationships may be an inclusion relationship, a time sequence relationship, a causal relationship, or the like. Preferably, an arrow direction may further be used to represent which is the cause and which is the effect in the causal relationship, and a double-headed arrow may represent that the two knowledge points are mutual cause and effect of each other.

A node of a star graph may be represented by using a geometric graph which is a rectangular box in this embodiment. Text in the rectangular box is a label name of the knowledge point, and light or shade of four edges of the rectangular box respectively represent whether there is a relationship in terms of knowledge point structure between the knowledge point and other knowledge points or not. For example, if a top edge of the rectangular box is highlighted, there is a parent node above the rectangular box, and if a bottom edge of the rectangular box is dark, there is no child node below the rectangular box. Similarly, light and shade of the side edges of the rectangular box are used for representing whether there is a brother node.

Using light or shade of lines to represent whether there is a neighboring parent node, child node, or brother node has practical significance. Because the star graph is generally preferably displayed on a touchscreen of a smartphone with a small size screen, generally, only a local structure close to the current knowledge point in the entire knowledge point structure system can be displayed on the screen. When needing to search for a knowledge point that is not displayed on a current interface, a user can directly move, on the touchscreen by using a gesture operation, the knowledge points displayed on the screen. The light or shade of the edges of the rectangular box is used for indicating moving boundary. When an edge of the rectangular box is highlighted, the user is informed that there is another node associated with the current knowledge point in a direction corresponding to the edge, and when an edge of the rectangular box is dark, the user is informed that there is no other node associated with the current knowledge point in a direction corresponding to the edge.

For the gesture operation mentioned in the previous paragraph, correspondingly, the network terminal 1a may further comprise a gesture recognition module 14a, and the gesture recognition module 14a is configured to recognize an operation gesture of the user on the star graph displayed on the first portion of the display screen of the network terminal, and move, according to the gesture, the node displayed on the star graph.

For example, when the user searches for a key word “Belt and Road” in the network terminal 1a, this search request is submitted to the server 2a, and a search strategy is executed in the server 2a to find the knowledge point of “Belt and Road”. The server 2a transmits data of an entire knowledge point structure system comprising the knowledge point of “Belt and Road” to the corresponding network terminal 1a by using a second transmission module 21a. The data comprises classifications, labels, structure relationships, and content of all the knowledge points.

The network terminal 1a stores the received data in its storage device, based on a setting of the star graph (for example, at most five nodes are displayed at the level of the current knowledge point, at most three levels of parent nodes above the current knowledge point are displayed, at most one lower level of child nodes are displayed, a knowledge point used as a search result is placed in the center position of the star graph, and the like), the local structure of the knowledge point system comprising the current knowledge point is captured, and correspondingly displayed on the touchscreen. If a gesture operation of the user on the touchscreen is received, the network terminal 1a re-captures a local structure of the corresponding knowledge point system from the storage device based on the gesture, and updates the display on the touchscreen.

Certainly, if the storage space of the network terminal 1a is insufficient or the transmitted data amount of the entire knowledge point system is excessively large, it is not needed to transmit the entire knowledge point system at the first. The server 2a captures, based on the setting of the star graph, the local structure of the knowledge point system comprising the current knowledge point, and transmits the data of the local structure to the network terminal 1a, such that the local structure is displayed on the touchscreen. If a gesture operation of the user on the touchscreen is received, the server 2a re-captures the local structure of the corresponding knowledge point system based on the gesture, and transmits data of the local structure to the network terminal 1a, and the local structure is displayed on the touchscreen.

The knowledge point content display module 12a is configured to display the content of the current knowledge point at the lower portion of the display screen of the network terminal. The content comprises text content and multimedia content of the knowledge point. For example, in FIG. 4A, a left lower portion is the text content of the knowledge point, and a right lower portion is the multimedia content of the knowledge point.

FIG. 4B shows a case in which the current knowledge point is located at the top level in the entire knowledge point structure system. In this case, the user cannot move the current knowledge point upward by using the gesture operation. FIG. 4C shows a case in which the current knowledge point is located at the bottom level in the entire knowledge point structure system. In this case, the user cannot move the current knowledge point downward by using the gesture operation.

In this embodiment, the network terminal 1a displays the local structure comprising the current knowledge point on the screen by using the star graph, and simultaneously displays the content of the current knowledge point. The star graph display is very suitable for a device with a small size screen, and has a better application effect in a smartphone.

Second Embodiment of a Network Terminal-Based Learning Display Device

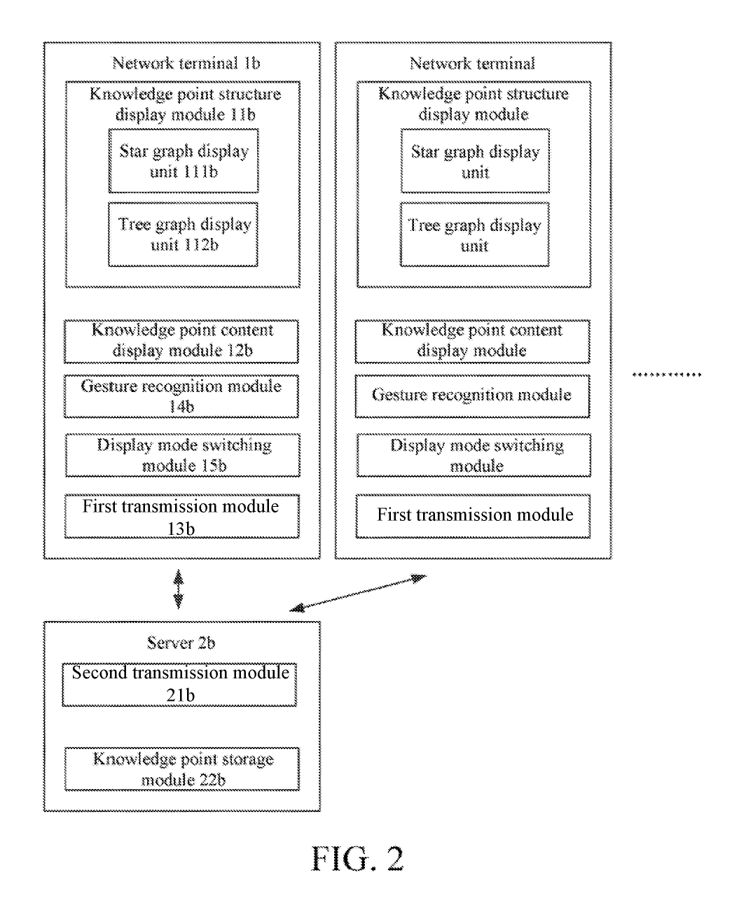

FIG. 2 shows the principle of the second embodiment of the network terminal-based learning display device according to the present invention. Referring to FIG. 2, the network terminal-based learning display device according to this embodiment comprises a network terminal 1b and a server 2b. The network terminal 1b may be a computer having a network function, or a smartphone, and establishes a communications connection to the server 2b by using the Internet or a mobile communications network.

The server 2b comprises a second transmission module 21b and a knowledge point storage module 22b. The second transmission module 21b is configured to transmit all or a part of data in the knowledge point storage module 22b to the network terminal 1b. The knowledge point storage module 22b is configured to store a classification, a structural relationship, a tag, and content of a knowledge point. The classification of the knowledge point refers to a category defined by an editor for the knowledge point. For example, “Belt and Road” is classified into the “economy” category under editing of a user A, but may be classified into the “politics” category under editing of a user B. Different users may classify a same knowledge point into different classifications due to their different understandings.

The label of the knowledge point is similar to a name of the knowledge point. For example, “Belt and Road” is the label of this knowledge point. The content of the knowledge point is a specific definition of the knowledge point. For example, what “Belt and Road” specifically refers to is the content under the “Belt and Road” label.

The structural relationship of the knowledge point refers to a logic relationship between knowledge points. The logic relationship is preferably expressed by using a tree data structure. A parent-child node relationship represents a hierarchy relationship between the knowledge points, and a brother node relationship represents a parallel relationship between the knowledge points. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-Hebei Integration Plan”, “Yangtze River Economic Zone”, “Free Trade Area”, “Western Region Development”, “Revitalization of Northeast”, and the like.

When an editor enters a knowledge point, in addition to content of the knowledge point, the editor further enters relationships between the knowledge point and other knowledge points. For example, for a currently entered knowledge point A and an existing knowledge point B, when the knowledge point A is entered, a relationship between the knowledge point A and the knowledge point B is also entered, the relationship may be classified into: no relationship between A and B, or a parallel relationship between A and B. If there is the parallel relationship between A and B, it indicates that granularities of the knowledge points A and B are the same. The parallel relationship may further be classified into three categories, namely, a causal relationship, no causal relationship but with a learning sequence, no causal relationship and no learning sequence.

Similarly, for the currently entered knowledge point A and a plurality of existing knowledge points B, C, D, and the like, there is no relationship or there is a parallel relationship (the parallel relationship is further classified into three categories, namely, a causal relationship, no causal relationship but with a learning sequence, no causal relationship and no learning sequence) therebetween. Furthermore, there is an implication/subordinate relationship between the knowledge point A and the plurality of existing knowledge points B, C, D, and the like.

The network terminal 1b comprises a knowledge point structure display module 11b, a knowledge point content display module 12b, a first transmission module 13b, and a display mode switching module 15b. The first transmission module 13b is configured to transmit data in the network terminal 1b to the server 2b.

The display of the knowledge point on the network terminal comprises two portions. One portion is the position of the current knowledge point in an entire knowledge structure and relationships between the current knowledge point and other neighboring knowledge points of the current knowledge point, that is, a display of the knowledge point structure. The other portion is specific content of the current knowledge point, that is, a display of the content of the knowledge point. The former is implemented by using the knowledge point structure display module 11b, and the latter is implemented by using the knowledge point content display module 12b.

A display screen of the network terminal 1b is comprises two portions, for example, an upper portion and a lower portion, or a left portion and a right portion. In this embodiment, the upper portion and the lower portion are used as an example for description. In this embodiment, the knowledge point structure display module 11b comprises a star graph display unit 111b. The star graph display unit 111b is configured to display the knowledge point structure in a star graph display mode on the upper portion of the display screen of the network terminal, and the displayed knowledge point structure comprises the current knowledge point. Correspondingly, the knowledge point content display module 12b is configured to display the content of the current knowledge point on the lower portion of the display screen of the network terminal.

The knowledge point structure displayed in the star graph display mode is shown in FIG. 4A to FIG. 4C. In FIG. 4A, a structure of a knowledge point displayed in the star graph display mode is displayed on the upper portion of the display screen. The current knowledge point is located in the center, an upper level of the current knowledge point is a parent node, and a still upper level is a grandparent node (that is, parent node of the parent node), and so on. A lower level of the current knowledge point is a child node, and a still lower level is a grandchild node (that is, child node of the child node), and so on. Because there are too many nodes when it comes to the grandchild node, generally, the current knowledge point is preferably unfolded to the level of the child nodes. A left node or a right node of the current knowledge point is a brother node. The relationships between the knowledge points are expressed by using connecting lines between the knowledge points. In terms of a data structure, such relationships are the foregoing parent-child relationship, brother relationship, or the like. In terms of a logic relationship, such relationships may be an inclusion relationship, a time sequence relationship, a causal relationship, or the like. Preferably, an arrow direction may further be used to represent which is the cause and which is the effect in the causal relationship, and a double-headed arrow may represent that the two knowledge points are mutual cause and effect of each other.

A node of a star graph may be represented by using a geometric graph which is a rectangular box in this embodiment. Text in the rectangular box is a label name of the knowledge point, and light or shade of four edges of the rectangular box may represent whether there is a relationship in terms of knowledge point structure between the knowledge point and other knowledge points or not. For example, if a top edge of the rectangular box is highlighted, there is a parent node above the rectangular box, and if a bottom edge of the rectangular box is dark, there is no child node below the rectangular box. Similarly, light and shade of the side edges of the rectangular box are used for representing whether there is a brother node.

Using light or shade of lines to represent whether there is a neighboring parent node, child node, or brother node has practical significance. Because the star graph is generally preferably displayed on a touchscreen of a smartphone with a small size screen, generally, only a local structure close to the current knowledge point in the entire knowledge point structure system can be displayed on the screen. When needing to search for a knowledge point that is not displayed on a current interface, a user can directly move, on the touchscreen by using a gesture operation, the knowledge points displayed on the screen. The light or shade of the edges of the rectangular box is used for indicating moving boundary. When an edge of the rectangular box is highlighted, the user is informed that there is another node associated with the current knowledge point in a direction corresponding to the edge, and when an edge of the rectangular box is dark, the user is informed that there is no other node associated with the current knowledge point in a direction corresponding to the edge.

For the gesture operation mentioned in the previous paragraph, correspondingly, the network terminal 1b may further comprise a gesture recognition module 14b, and the gesture recognition module 14b is configured to recognize an operation gesture of the user on the star graph displayed on the first portion of the display screen of the network terminal, and move, according to the gesture, the node displayed on the star graph.

For example, when the user searches for a key word “Belt and Road” in the network terminal 1b, this search request is submitted to the server 2b, and a search strategy is executed in the server 2b to find the knowledge point of “Belt and Road”. The server 2b transmits data of an entire knowledge point structure system comprising the knowledge point of “Belt and Road” to the corresponding network terminal 1b by using a second transmission module 21b. The data comprises classifications, labels, structure relationships, and content of all the knowledge points.

The network terminal 1b stores the received data in its storage device, based on a setting of the star graph (for example, at most five nodes are displayed at the level of the current knowledge point, at most three levels of parent nodes above the current knowledge point are displayed, at most one lower level of child nodes are displayed, a knowledge point used as a search result is placed in the center position of the star graph, and the like), the local structure of the knowledge point system comprising the current knowledge point is captured, and correspondingly displayed on the touchscreen. If a gesture operation of the user on the touchscreen is received, the network terminal 1b re-captures a local structure of the corresponding knowledge point system from the storage device based on the gesture, and updates the display on the touchscreen.

Certainly, if the storage space of the network terminal 1b is insufficient or the transmitted data amount of the entire knowledge point system is excessively large, it is not needed to transmit the entire knowledge point system at the first. The server 2b captures, based on the setting of the star graph, the local structure of the knowledge point system comprising the current knowledge point, and transmits the data of the local structure to the network terminal 1b, such that the local structure is displayed on the touchscreen. If a gesture operation of the user on the touchscreen is received, the server 2b re-captures the local structure of the corresponding knowledge point system based on the gesture, and transmits data of the local structure to the network terminal 1b, and the local structure is displayed on the touchscreen.

The knowledge point content display module 12b is configured to display the content of the current knowledge point at the lower portion of the display screen of the network terminal. The content comprises text content and multimedia content of the knowledge point. For example, in FIG. 4A, a left lower portion is the text content of the knowledge point, and a right lower portion is the multimedia content of the knowledge point.

FIG. 4B shows a case in which the current knowledge point is located at the top level in the entire knowledge point structure system. In this case, the user cannot move the current knowledge point upward by using the gesture operation. FIG. 4C shows a case in which the current knowledge point is located at the bottom level in the entire knowledge point structure system. In this case, the user cannot move the current knowledge point downward by using the gesture operation.

The network terminal 1b displays the local structure comprising the current knowledge point on the screen by using the star graph, and simultaneously displays the content of the current knowledge point. The star graph display is very suitable for a device with a small size screen, and has a better application effect in a smartphone.

This embodiment differs from the first embodiment in that: in addition to the star graph display mode, a tree graph display mode is further provided, and a switch may be performed between the two display modes based on input of the user.

Referring to FIG. 2, the network terminal 1b comprises a display mode switching module 15b, and the knowledge point structure display module 11b further comprises a tree graph display unit 112b besides the star graph display unit 111b.

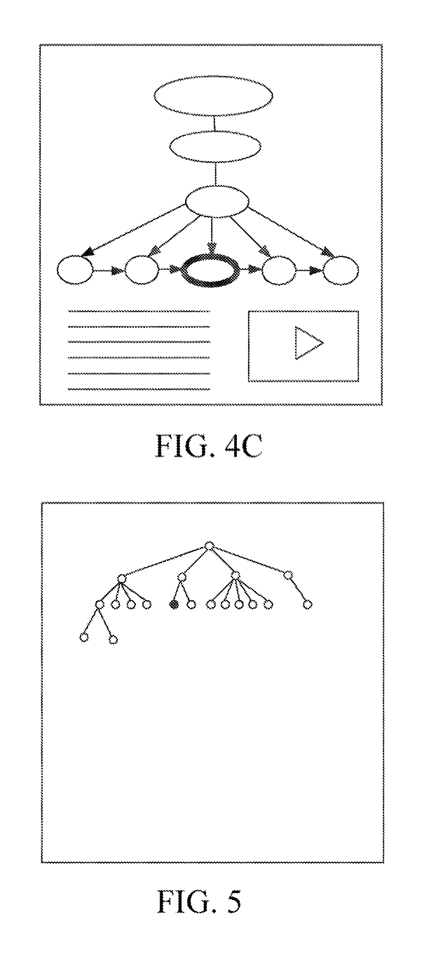

The tree graph display unit 112b displays the knowledge point structure in the tree graph display mode on the display screen of the network terminal. A specific example is shown in FIG. 5. FIG. 5 shows a knowledge point structure system of a tree graph, and the current knowledge point is highlighted in the tree graph.

A switching button is provided on a display interface of a screen. For example, on a star graph display interface, the button is displayed as “entirety”. When a user clicks the “entirety” button, the display mode switching module 15b receives a switching instruction, instructs the star graph display unit 111b to stop working, and instructs to display the tree graph display unit 112b, so that a star graph display on the display screen is switched to a tree graph display.

On the contrary, in a graph display interface, the button is displayed as “local”. When a user clicks the “local” button, the display mode switching module 15b receives a switching instruction, instructs the tree graph display unit 112b to stop working, and instructs to display the star graph display unit 111b, so that the tree graph display on the display screen is switched to the star graph display.

In this embodiment, two display modes are provided for the user, namely, the star graph and the tree graph. The star graph helps the user to specifically learn the knowledge point, and understand neighboring knowledge points associated with the knowledge point, and the tree graph helps the user to understand the level and position of the current knowledge point in the entire knowledge point structure system. Furthermore, a function of switching between the two displays modes is provided for the user.

Third Embodiment of a Network Terminal-Based Learning Display Device

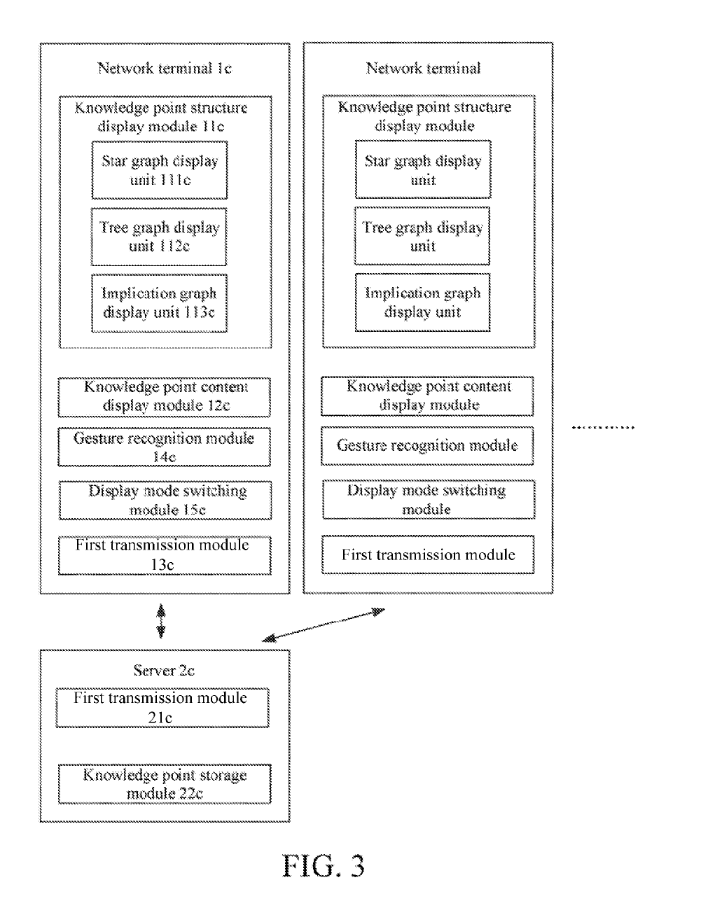

FIG. 3 shows a principle of the third embodiment of the network terminal-based learning display device according to the present invention. Referring to FIG. 3, the network terminal-based learning display device according to this embodiment comprises a network terminal 1c and a server 2c. The network terminal 1c may be a computer having a network function, or a smartphone, and establishes a communications connection to the server 2c by using the Internet or a mobile communications network.

The server 2c comprises a second transmission module 21c and a knowledge point storage module 22c. The second transmission module 21c is configured to transmit all or a part of data in the knowledge point storage module 22c to the network terminal 1c. The knowledge point storage module 22c is configured to store a classification, a structural relationship, a tag, and content of a knowledge point. The classification of the knowledge point refers to a category defined by an editor for the knowledge point. For example, “Belt and Road” is classified into the “economy” category under editing of a user A, but may be classified into the “politics” category under editing of a user B. Different users may classify a same knowledge point into different classifications due to different understandings.

The label of the knowledge point is similar to a name of the knowledge point. For example, “Belt and Road” is the label of this knowledge point. The content of the knowledge point is a specific definition of the knowledge point. For example, what “Belt and Road” specifically refers to is the content under the “Belt and Road” label.

The structural relationship of the knowledge point refers to a logic relationship between knowledge points. The logic relationship is preferably expressed by using a tree data structure. A parent-child node relationship represents a hierarchy relationship between the knowledge points, and a brother node relationship represents a parallel relationship between the knowledge points. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road Initiative” are “Beijing-Tianjin-Hebei Integration Plan”, “Yangtze River Economic Zone”, “Free Trade Area”, “Western Region Development”, “Revitalization of Northeast”, and the like.

Similarly, for the currently enters knowledge point A and a plurality of existing knowledge points B, C, D, and the like, there is no relationship or there is a parallel relationship (the parallel relationship is further divided into three categories, namely, a causal relationship, no causal relationship but with a learning sequence, no causal relationship and no learning sequence) therebetween. Furthermore, there is an implication/subordinate relationship between the knowledge point A and the plurality of existing knowledge points B, C, D, and the like.

When an editor enters a knowledge point, in addition to content of the knowledge point, the editor further enters relationships between the knowledge point and other knowledge points. For example, for a currently entered knowledge point A and an existing knowledge point B, when the knowledge point A is logged, a relationship between the knowledge point A and the knowledge point B is also entered, and there may be no relationship between the A and the B, or there may be a parallel relationship between the A and the B. If there is the parallel relationship between the A and the B, it shows that granularities of the knowledge points A and B are the same. The parallel relationship may further be classified into three categories, namely, a causal relationship, no causal relationship but with a learning sequence, no causal relationship and no learning sequence.

The network terminal 1c comprises a knowledge point structure display module 11c, a knowledge point content display module 12c, a first transmission module 13c, and a display mode switching module 15c. The first transmission module 13c is configured to transmit data in the network terminal 1c to the server 2c.

The display of the knowledge point on the network terminal comprises two portions. One portion is the position of the current knowledge point in an entire knowledge structure and relationships between the current knowledge point and other neighboring knowledge points of the current knowledge point, that is, a display of the knowledge point structure. The other portion is specific content of the current knowledge point, that is, a display of the content of the knowledge point. The former is implemented by using the knowledge point structure display module 11c, and the latter is implemented by using the knowledge point content display module 12c.

A display screen of the network terminal 1c comprises two portions, for example, an upper portion and a lower portion, or a left portion and a right portion. In this embodiment, the upper portion and the lower portion are used as an example for description. In this embodiment, the knowledge point structure display module 11c comprises a star graph display unit 111c. The star graph display unit 111c is configured to display the knowledge point structure in a star graph display mode on the upper portion of the display screen of the network terminal, and the displayed knowledge point structure comprises the current knowledge point. Correspondingly, the knowledge point content display module 12c is configured to display the content of the current knowledge point on the lower portion of the display screen of the network terminal.

The knowledge point structure displayed in the star graph display mode is shown in FIG. 4A to FIG. 4C. In FIG. 4A, a structure of a knowledge point displayed in the star graph display mode is displayed on the upper portion of the display screen. The current knowledge point is located in the center, an upper level of the current knowledge point is a parent node, and a still upper level is a grandparent node (that is, parent node of the parent node), and so on. A lower level of the current knowledge point is a child node, and a still lower level is a grandchild node (that is, child node of the child node), and so on. Because there are too many nodes when it comes to the grandchild node, generally, the current knowledge point is preferably unfolded to the level of the child nodes. A left node or a right node of the current knowledge point is a brother node. The relationships between the knowledge points are expressed by using connecting lines between the knowledge points. In terms of a data structure, such relationships are the foregoing parent-child relationship, brother relationship, or the like. In terms of a logic relationship, such relationships may be an inclusion relationship, a time sequence relationship, a causal relationship, or the like. Preferably, an arrow direction may further be used to represent which is the cause and which is the effect in the causal relationship, and a double-headed arrow may represent that the two knowledge points are mutual cause and effect of each other.

A node of a star graph may be represented by using a geometric graph which is a rectangular box in this embodiment. Text in the rectangular box is a label name of the knowledge point, and light or shade of four edges of the rectangular box respectively represent that there is a relationship in terms of knowledge point structure between the knowledge point and other knowledge points and there is no relationship in terms of the knowledge point structure between the knowledge point and other knowledge points or not. For example, if a top edge of the rectangular box is highlighted, there is a parent node above the rectangular box, and if a bottom edge of the rectangular box is dark, there is no child node below the rectangular box. Similarly, light and shade of the side edges of the rectangular box are used for representing whether there is a brother node.

It is of practical significance to represent whether there is a neighboring parent node, child node, or brother node has practical significance. Because the star graph is generally preferably displayed on a touchscreen of a smartphone with a small size screen, generally, only a local structure close to the current knowledge point in the entire knowledge point structure system can be displayed on the screen. When needing to search for a knowledge point that is not displayed on a current interface, a user can directly move, on the touchscreen by using a gesture operation, the knowledge points displayed on the screen. The light or shade of the edges of the rectangular box is used for indicating moving boundary. When an edge of the rectangular box is highlighted, the user is informed that there is another node associated with the current knowledge point in a direction corresponding to the edge, and when an edge of the rectangular box is dark, the user is informed that there is no other node associated with the current knowledge point in a direction corresponding to the edge.

For the gesture operation mentioned in the previous paragraph, correspondingly, the network terminal 1c may further comprise a gesture recognition module 14c, and the gesture recognition module 14c is configured to recognize an operation gesture of the user on the star graph displayed on the first portion of the display screen of the network terminal, and move, according to the gesture, the node displayed on the star graph.

For example, when the user searches for a key word “Belt and Road” in the network terminal 1c, this search request is submitted to the server 2c, and a search strategy is executed in the server 2c to find the knowledge point of “Belt and Road”. The server 2c transmits data of an entire knowledge point structure system comprising the knowledge point of “Belt and Road” to the corresponding network terminal 1c by using a second transmission module 21c. The data comprises classifications, label, structure relationships, and content of all the knowledge points.

The network terminal 1c stores the received data in its storage device of, based on the setting of a star graph (for example, at most five nodes are displayed at the level of the current knowledge point, at most three levels of parent nodes above the current knowledge point are displayed, at most one lower level of child nodes are displayed, a knowledge point used as a search result is placed in the center position of the star graph, and the like), the local structure of the knowledge point system comprising the current knowledge point is captured, and correspondingly displayed the local structure on the touchscreen. If a gesture operation of the user on the touchscreen is received, the network terminal 1c re-captures a local structure of the corresponding knowledge point system from the storage device based on the gesture, and updates the display on the touchscreen.

Certainly, if the storage space of the network terminal 1c is insufficient or the transmitted data amount of the entire knowledge point system is excessively large, it is not needed to transmit the entire knowledge point system at the first. The server 2c captures, based on the setting of the star graph, the local structure of the knowledge point system comprising the current knowledge point, and transmits the data of the local structure to the network terminal 1c, such that the local structure is displayed on the touchscreen. If a gesture operation of the user on the touchscreen is received, the server 2c re-captures the local structure of the corresponding knowledge point system based on the gesture, and transmits data of the local structure to the network terminal 1c, and the local structure is displayed on the touchscreen.

The knowledge point content display module 12c is configured to display the content of the current knowledge point at the lower portion of the display screen of the network terminal. The content comprises text content and multimedia content of the knowledge point. For example, in FIG. 4A, a left lower portion is the text content of the knowledge point, and a right lower portion is the multimedia content of the knowledge point.

FIG. 4B shows a case in which the current knowledge point is located at the top level in the entire knowledge point structure system. In this case, the user cannot move the current knowledge point upward by using the gesture operation. FIG. 4C shows a case in which the current knowledge point is located at the bottom level in the entire knowledge point structure system. In this case, the user cannot move the current knowledge point downward by using the gesture operation.

The network terminal 1c displays the local structure comprising the current knowledge point on the screen by using the star graph, and simultaneously displays the content of the current knowledge point. The star graph display is very suitable for a device with a small size screen, and has a better application effect in a smartphone.

This embodiment differs from the foregoing two embodiments in that: in this embodiment, in addition to the star graph display mode, a tree graph display mode and an implication graph display mode are further provided, and a switch may be performed between the three display modes based on input of the user.

Referring to FIG. 2, the network terminal 1c comprises a display mode switching module 15c, and the knowledge point structure display module 11c further comprises a tree graph display unit 112c and an implication graph display unit 113c besides the star graph display unit 111c.

The tree graph display unit 112c displays the knowledge point structure in the tree graph display mode on the display screen of the network terminal. A specific example is shown in FIG. 5. FIG. 5 shows the knowledge point structure system of a tree graph, and the current knowledge point is highlighted in the tree graph.

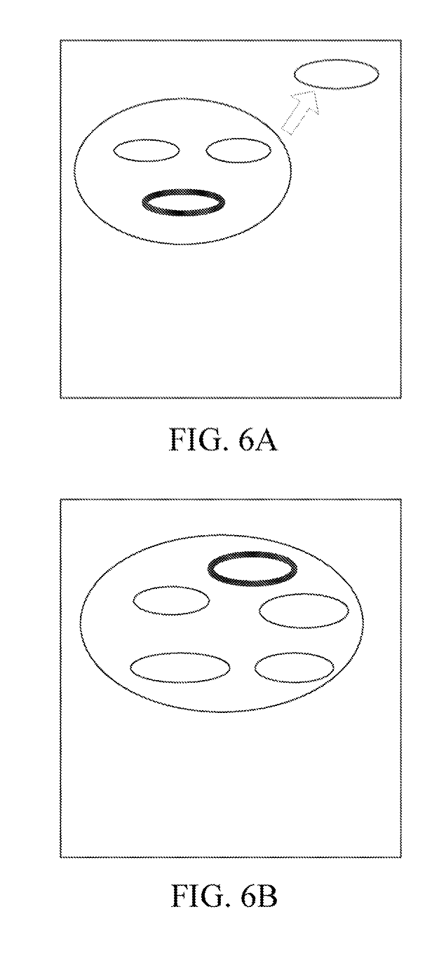

The implication graph display unit 113c displays the knowledge point structure in the implication graph mode on the display screen of the network terminal. A specific example is shown in FIG. 6A and FIG. 6B. In FIG. 6A, mainly a local set of a knowledge point is displayed on an interface, the current knowledge point (represented by using a thick line box) is located in the local set, and an arrow outside the local set is used to represent a set of an upper level that comprises the local set. In FIG. 6B, a set of a top level is displayed on an interface. In this case, there is no arrow representing a set of an upper level because the set on the interface is the set of the top level. The current knowledge point is represented by using a thick line box. Alternatively, for sets in an implication graph, a connecting line may be used to represent that a relationship exists between the sets. Such connecting lines vary in width, and a thicker connecting line between the two sets indicates more connecting lines between granule knowledge points in two sets.

A switching button is provided on the display interface of a screen. For example, the switching button is displayed as “tree graph”. When the switching button is clicked, the display mode switching module 15c receives a switching instruction, instructs the star graph display unit 111c and the implication graph display unit 113c to stop working, and simultaneously instructs to display the tree graph display unit 112c, so that the tree graph is switched to on the display screen.

Furthermore, the switching button is displayed as “star graph”. When a user clicks the “star graph” button, the display mode switching module 15c receives a switching instruction, instructs the tree graph display unit 112c and the implication graph display unit 113c to stop working, and simultaneously instructs to display the star graph display unit 111c, so that the star graph is switched to on the display screen.

Furthermore, the switching button is displayed as “implication graph”. When the user clicks the “implication graph” button, the display mode switching module 15c receives a switching instruction, instructs the star graph display unit 111c and the tree graph display unit 112c to stop working, and simultaneously instructs to display the implication graph display unit 113c, so that the implication graph is switched to on the display screen.

Besides a manner of clicking a button to perform a switching operation, the switching operation may alternatively be performed by using a mouse operation. For example, the display is implemented by using the star graph by default, a click is performed to switch to displaying by using the implication graph, and a double-click is performed to switch to displaying by using the tree graph.

In this embodiment, three display modes are provided for the user, namely, the star graph, the tree graph, and the implication graph. The star graph helps the user to specifically learn the knowledge point, and understand neighboring knowledge points associated with the knowledge point; the tree graph helps the user to understand the level and position of the current knowledge point in the entire knowledge point structure system; and the implication graph helps the user to understand inclusion relationships between the knowledge points. Furthermore, a function of switching between the three displays modes is provided for the user.

Although for brief explanation, the foregoing methods are shown and described as a series of actions, it should be understood and comprehended that these methods are not limited by the sequence of the actions because according to one or more embodiments, some actions may be performed according to a different sequence and/or may be performed simultaneously with other actions shown or described herein or other actions that are not shown and described herein but can be understood by a person skilled in the art.

The person skilled in the art further comprehends that various illustrative logical portions, modules, circuits, and algorithm steps that are described in combination with the embodiments disclosed herein may be implemented as electronic hardware, computer software, or a combination thereof. To clearly illustrate the interchangeability between hardware and software, various illustrative components, blocks, modules, circuits, and steps have been generally described above in a form of their functionality. Whether such functionality is implemented as the hardware or software depends upon a specific application and a design constraint imposed on the overall system. The technical person may implement the described functionality for each specific application by using different methods, but such an implementation decision should not be interpreted as departing from the scope of the present invention.

The various illustrative logical portions, modules, and circuits that are described in combination with the embodiments disclosed herein can be implemented or executed by using a general purpose processor, a digital signal processor (DSP), an application-specific integrated circuit (ASIC), a field programmable gate array (FPGA) or another programmable logic device, a discrete gate or a transistor logic, a discrete hardware component, or any combination designed to execute the functions described herein. The general processor may be a micro processor, but in an alternative solution, the processor may be any conventional processor, controller, micro controller, or state machine. Alternatively, the processor may be implemented as a combination of computing devices, for example, a combination of the DSP and the micro processor, multiple micro processors, one or more micro processors cooperating with the DSP core, or any other configurations of this type.

Steps of the method or algorithm that are described in combination with the embodiments disclosed herein may be directly reflected in hardware, a software module executed by the processor, or a combination thereof. The software module may reside in a random access memory (RAM), a flash memory, a read-only memory (ROM), an erasable programmable read-only memory (EPROM), an electrically erasable programmable read-only memory (EEPROM), a register, a hard disk, a removable disk, a CD-ROM, or a storage medium of any other form already known in the art. Exemplarily, a storage medium is coupled to a processor, so that the processor reads or writes information from/into the storage medium. In an alternative solution, the storage medium may be integrated with the processor. The processor and the storage medium may reside in the ASIC. The ASIC may reside in a user terminal. In an alternative solution, the processor and the storage medium may reside in the user terminal as discrete components.

In one or more exemplary embodiments, the described functions may be implemented in hardware, software, a hard drive, or any combination thereof. If implemented as a computer program product in the software, the functions may be stored in a computer readable medium as one or more instructions or code or be transmitted by using the instructions or code. The computer readable medium comprises a computer storage medium and a communications medium, and the communications medium comprises any medium that facilitates transmission of a computer program from one place to another place. The storage medium may be any available medium accessible to a computer. As an example rather than a limitation, such a computer readable medium may comprise a RAM, a ROM, an EEPROM, a compact disc read-only memory (CD-ROM), or other optical disk storage, magnetic disk storage or other magnetic storage devices, or any other medium that can be used to carry or store expected program code in an instruction or data structure form and can be accessed by a computer. Any connection may be appropriately referred to as a computer-readable medium. For example, if software is transmitted from a website, a server, or another remote source by using a coaxial cable, an optical cable, a twisted pair, a digital subscriber line (DSL), or wireless technologies such as infrared ray, radio, and microwave, the coaxial cable, optical cable, twisted pair, DSL, or wireless technologies such as infrared ray, radio, and microwave are comprised in definition of a medium. For example, a disk and disc used herein comprises a compact disc (CD), a laser disc, an optical disc, a digital versatile disc (DVD), a floppy disk, and a Blu-ray disc, and the disk generally reproduces data in a magnetic manner, and the disc reproduces data by using a laser in an optical manner. The foregoing combinations should also be comprised within the scope of the computer-readable medium.

The foregoing descriptions of the present disclosure are provided only to enable any person skilled in the art to manufacture or use the present disclosure. Various modifications to the present disclosure are apparent to a person skilled in the art, and the generic principles defined herein may be applied to other variants without departing from the spirit or scope of the present disclosure. Accordingly, the present disclosure should not be limited to the embodiments and designs described herein, but should be granted with the broadest scope consistent with the principles and novel features disclosed herein.

What is claimed is:

1. A network terminal-based learning display device, comprising a network terminal and a server, wherein
the network terminal comprises:
a knowledge point structure display module, configured to display a knowledge point structure in a first display mode on a first portion of a display screen of the network terminal, wherein the displayed knowledge point structure comprises a current knowledge point;
a knowledge point content display module, configured to display content of the current knowledge point on a second portion of the display screen of the network terminal; and
a first transmission module, configured to transmit data in the network terminal to the server; and
the server comprises:
a knowledge point storage module, configured to store a classification, a structural relationship, a label, and content of a knowledge point; and a second transmission module, configured to transmit data in the knowledge point storage module to the network terminal.

2. The network terminal-based learning display device according to claim 1, wherein the first display mode is a star graph display mode, the knowledge point structure display module comprises a star graph display unit, and the star graph display unit is configured to display the knowledge point structure in the star graph display mode on the first portion of the display screen of the network terminal.

3. The network terminal-based learning display device according to claim 2, wherein the knowledge point structure display module is further configured to display the knowledge point structure in a second display mode on the first portion of the display screen of the network terminal, wherein the displayed knowledge point structure comprises the current knowledge point; and
the network terminal further comprises:
a display mode switching module, configured to switch between the first display mode and the second display mode according to user's input.

4. The network terminal-based learning display device according to claim 3, wherein the second display mode is a tree graph display mode, the knowledge point structure display module further comprises a tree graph display unit, and the tree graph display unit is configured to display the knowledge point structure in the tree graph display mode on the first portion of the display screen of the network terminal.

5. The network terminal-based learning display device according to claim 2, wherein the knowledge point storage module is configured to store the structural relationships, the labels, and the content of the knowledge points by using a tree data structure.

6. The network terminal-based learning display device according to claim 2, wherein the knowledge point structure display module displays the structural relationships of the knowledge points in the star graph display mode, and N parent nodes, N neighboring brother nodes, and N child nodes centering on the current knowledge point are displayed on the first portion of the display screen of the network terminal, wherein N is a natural number greater than or equal to 1, a label of knowledge point is displayed on a node of a star graph, and a connecting line or an arrow between nodes represents a structural relationship between knowledge points.

7. The network terminal-based learning display device according to claim 5, wherein a node of a star graph is represented by using a rectangular box, text in the rectangular box is a label of a knowledge point, and light or shade of an edge of the rectangular box respectively represent whether there is a structural relationship between knowledge points or not.

8. The network terminal-based learning display device according to claim 6, wherein the network terminal further comprises:
a gesture recognition module, configured to recognize an operation gesture of a user on the star graph displayed on the first portion of the display screen of the network terminal, and move, based on the gesture, the node displayed on the star graph.

9. The network terminal-based learning display device according to claim 4, wherein the knowledge point structure display module of the learning display device is further configured to display the knowledge point structure in a third display mode on the first portion of the display screen of the network terminal, wherein the third display mode is an implication graph mode; the knowledge point structure display module further comprises an implication graph display unit, and the implication graph display unit is configured to display the knowledge point structure in an implication graph display mode on the first portion of the display screen of the network terminal; and the display mode switching module is configured to receive the input of the user, then switch between the first display mode, the second display mode, and the third display mode accordingly.

10. The network terminal-based learning display device according to claim 1, wherein the content of the current knowledge point displayed by the knowledge point content display module comprises text content and multimedia content of the knowledge point.
